(19) United States
(12) Patent Application Publication
(10) Pub. No.: US 2011/0288688 A1
(43) Pub. Date: Nov. 24, 2011

(54) SYSTEM AND METHOD FOR GENERATING ELECTRIC POWER

(76) Inventor: William Lehan, Falls Church, VA (US)

(21) Appl. No.: 12/783,955

(22) Filed: May 20, 2010

(51) Int. Cl. G06F 1/26; G05D 7/06; G05D 16/20; H02J 7/35

(52) U.S. Cl. 700/282; 320/101; 700/287

(57) ABSTRACT

A reversible system for generating electric power includes a first reservoir initially containing a predetermined volume of water, a second reservoir initially being substantially empty, a turbine selectively connectable to the first and second reservoirs through multiple valves, and a generator connected to the turbine to generate electric power. An air bank selectively provides pressurized air to the first reservoir during an initial operational time period to increase an internal pressure of the first reservoir. An air compressor operates only at times other than the initial operational time period to charge the air bank. At least a first valve is opened during the initial operational time period to enable the water to flow from the first reservoir through the turbine to the second reservoir, in response to the increased internal pressure, causing the turbine and the generator to generate electric power.

### BACKGROUND

Electric power is typically provided to customers through a power grid by a utility company. The utility company must have sufficient generating capacity to provide power during periods of maximum demand by its customers, referred to as peak-power periods. For example, a peak-power period may occur daily between 10 a.m. and 3 p.m. during the week, which may be determined by monitoring daily usage. In order to discourage power usage during the peak-power period, the utility company may charge customers higher rates during the peak-power period than during off-peak times. This is done to cover the cost of the utility company's additional generating capacity needed only during this peak demand period. A utility company may encourage its customers to reduce electrical consumption during the peak-power period, referred to as load shedding, and thus reduce generating capacity requirements.

Generally, there are two ways to reduce power consumption from the electric power grid. First is to reduce usage, for example, by turning off appliances, machinery and other electric loads. However, reducing usage is not always practical, especially for commercial customers who may not have the flexibility to cut back during the peak-power period. Second is to generate supplemental electric power through alternative and/or renewable energy sources, such as on-site solar, wind and hydroelectric power generating sources. However, solar and wind energy sources of significant size (e.g., sufficient to provide electric power for an office building or factory) may be cost prohibitive, and otherwise too dependent on environmental conditions to be consistently reliable. Hydroelectric power is able to generate larger amounts of electricity more consistently, but other limitations exist. For example, there are three basic types of hydroelectric power generation: dams, reservoirs and flows (rivers), all of which are limited by size and location. Also, in the case of reservoir systems that require water to be pumped by electric pumps to elevated levels, the pumps consume significant amounts of electricity, which may be cost prohibitive and substantially negate savings otherwise obtained by generating the hydroelectric power.

### SUMMARY

In a representative embodiment, a reversible system for generating electric power only during a periodically occurring operational time period includes a first reservoir initially containing a predetermined volume of water, a second reservoir initially being substantially empty, a turbine selectively connectable to the first and second reservoirs through multiple valves, and a generator connected to the turbine to generate electric power. An air bank selectively provides pressurized air to the first reservoir during an initial operational time period to increase an internal pressure of the first reservoir. An air compressor operates only at times other than the periodically occurring initial operational time period to charge the air bank. At least a first valve is opened during the initial operational time period to enable the water to flow from the first reservoir through the turbine to the second reservoir, in response to the increased internal pressure, causing the turbine and the generator to generate electric power.

In another representative embodiment, a method is provided for generating electric power only during periodically occurring operational time periods. The method includes charging air in an air bank to a target pressure prior to an initial operational time period; throttling the pressurized air from the air bank to a first reservoir during the initial operational time period to increase an internal pressure of the first reservoir, the first reservoir containing a predetermined volume of water; opening a first set of valves to enable at least a portion of the predetermined volume of water to flow in response to the increased internal pressure from the first reservoir through a turbine into a second reservoir, causing the turbine to operate a generator connected to the turbine for generating electric power; and closing the first set valves when the initial operational time period ends. The method further includes charging air in the air bank to the target pressure after the initial operation time period and prior to a subsequent operational time period; throttling the pressurized air from the air bank to the second reservoir during the subsequent operational time period to increase an internal pressure of the second reservoir, the second reservoir containing the portion of the predetermined volume of water received from the first reservoir; opening a second set of valves to enable the portion of the predetermined volume of water to flow in response to the increased internal pressure from the second reservoir through the turbine into the first reservoir, causing the turbine to operate the generator connected to the turbine for generating electric power; and closing the second set of valves when the subsequent operational time period ends.

In yet another representative embodiment, a system is provided for generating electric power only during a first time period. The system includes an air bank configured to contain compressed air at a predetermined pressure and an air compressor configured to charge the air bank to the predetermined pressure only during a second time period different from the first time period. The system further includes a first tank configured to contain a predetermined volume of water and a second tank configured to contain the predetermined volume of water, the second tank being connected to the first tank through at least one valve operable to enable the predetermined volume of water to be transferred between the first and second tanks. A turbine is configured to receive through the at least one valve the predetermined volume of water being transferred between the first and second tanks, and a generator is configured to generate the electric power by operation of the turbine. The portion of the predetermined volume of water is transferred from one of the first tank or the second tank to the other one of the first tank or the second tank during the first time period in response to pressure from the compressed air provided by the air bank.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 is a block diagram of a system for generating electric power, according to a representative embodiment.

FIG. 2 is a method for generating electric power, according to a representative embodiment.

FIG. 3 is a flow diagram of the system start-up process indicated in FIG. 2, according to a representative embodiment.

FIG. 4 is a flow diagram of the system shut-down and reset process indicated in FIG. 2, according to a representative embodiment.

FIG. 5 is a functional block diagram illustrating a controller for operating the electric power generating system, according to a representative embodiment.

### DETAILED DESCRIPTION

In the following detailed description, for purposes of explanation and not limitation, representative embodiments disclosing specific details are set forth in order to provide a thorough understanding of the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatuses and methods may be omitted so as to not obscure the description of the representative embodiments. Such methods and apparatuses are clearly within the scope of the present teachings.

Generally, it is understood that the drawings and the various elements depicted therein are not drawn to scale. Further, relative terms, such as “above,” “below,” “top,” “bottom,” “upper,” “lower,” “left,” “right,” “vertical” and “horizontal,” are used to describe the various elements' relationships to one another, as illustrated in the accompanying drawings. It is understood that these relative terms are intended to encompass different orientations of the device and/or elements in addition to the orientation depicted in the drawings.

According to various embodiments, electric power is efficiently generated by an artificial dam system, using a water turbine and attached generator, where the water turbine is operated by water flowing between first and second water tanks. For example, in an initial cycle, water from the first water tank flows through the water turbine into the second water tank by force of previously compressed air in an air bank, substantially emptying the first water tank and substantially filling the second water tank. In a subsequent cycle, the water from the second water tank flows through the water turbine into the first water tank by the force of previously compressed air in the air bank.

Accordingly, electric power may be generated over a periodically occurring operational time period, such as a daily peak-power period, reliant only on a relatively small amount of electric power for occasionally operating an air compressor to compress the air in the air bank (during times outside the operational time period), a pump down pump (PDP) to pump residual water from the first or second water tank, as needed, and/or a controller or computer for controlling overall operations, for example. In addition, electric power may be generated in emergencies, for example, when electric power from the grid is lost, so that electricity can be generated until electric power is restored or other supplies provided.

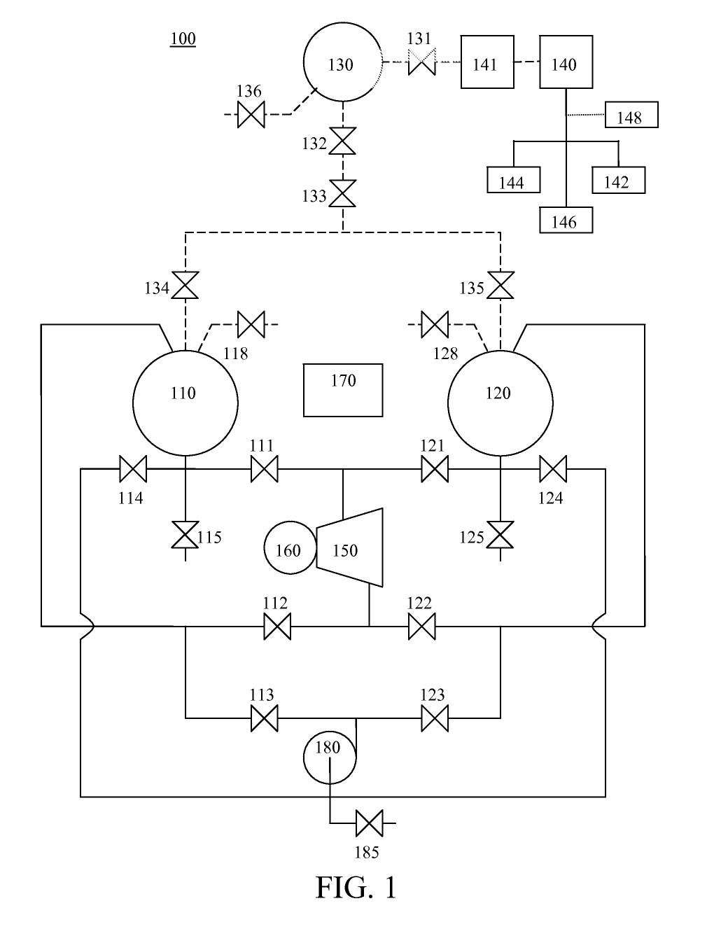

FIG. 1 is a system for generating electric power, according to a representative embodiment.

Referring to FIG. 1, electric power generating system 100 generates electric power periodically (e.g., during an operational time period), in order to provide supplemental electric power when needed. For example, the electric power generating system 100 may operate only during peak-power periods, and otherwise be substantially idle during off-peak times. Additionally, the electric power generating system 100 may be used to supply power during periods when power from the power grid is lost.

In the depicted embodiment, the electric power generating system 100 includes first water reservoir 110, second water reservoir 120, air bank 130, air compressor 140, water turbine 150, electric generator 160, controller 170 and pump down pump (PDP) 180. The electric power generating system 100 operates substantially independently of outside power sources, including the public electric power grid 146. For example, power may be provided by renewable energy sources, such as representative solar photo-voltaic 142 and wind generator 144, which may or may not contain a battery storage capability, such as optional battery 148 (having a connection indicated by a dotted line). The photo-voltaic 142 and/or wind generator 144 may operate continuously, as conditions permit, to supply trickle charge to the optional battery 148, when included.

Power may be selectively provided by the electric power grid 146, e.g., to provide power directly to the electric power generating system 100 or to recharge the optional battery 148, only to the extent the renewable energy sources are insufficient. In various embodiments, when power from the electric power grid 146 is needed, only off-peak-power is used in order to avoid further strain on the electric power grid 146 during peak-power periods.

Only the air compressor 140, the controller 170 (cooling fans, lights, control valves, etc.) and the PDP 180 require electric power provided by an outside power source, such as the electric power grid 146, the renewable energy sources (e.g., the solar photo-voltaic 142 and the wind generator 144), and/or the battery 148. The air compressor 140 only operates for relatively brief periods of time, and is otherwise secured, so that no additional electric power is consumed. More particularly, the air compressor 140 operates only long enough to fill the air bank 130 with pressurized air at a target air pressure, the value of which is predetermined based on various physical factors of the power generating system 100, such as the sizes of the first and second water reservoirs 110 or 120 and ratings of the turbine 150 and the electric generator 160. For example, the controller 170 controls the air compressor 140 and associated dryer 141 to start up, and air valve 131 to open in order to charge the air bank 130 to the target pressure. When the target pressure is reached, the air valve 131 is closed, and the air compressor 140 and the dryer 141 are secured. In various embodiments, the air compressor 140 is operated only during times other than the operational time period, e.g., off-peak times. This prevents placing additional load on the outside power source during the peak-power period or otherwise negating load shedding effects.

Similarly, the PDP 180 only operates for relatively brief periods of time to pump residual water out of one of the first or second water reservoirs 110 or 120 at the end of an operational cycle, as discussed below. Likewise, in various embodiments, the PDP 180 is operated only during off-peak times.

Generally, one of the first or second water reservoirs 110 or 120 is initially filled with a predetermined volume of water. This may be done prior to initial operation of the electric power generating system 100. Also, pursuant to normal operations, the one of the first or second water reservoirs 110 or 120 containing the water may need to be topped off periodically, e.g., during a non-operational or off-peak times, so that the electric power generating system 100 is able to continue operating at full capacity. The first and second water reservoirs 110 and 120 are sized to provide the necessary driving force to the turbine 150 for the entire operational time period during which supplemental electric power is desired (e.g., the peak-power period plus a cushion of about 15 minutes on each side of the peak-power period). In various embodiments, the first and second water reservoirs 110 and 120 are substantially the same size, at least with respect to volume, so that the water can be transferred back and forth between the first and second water reservoirs 110 and 120. Also, in various embodiments, one or both of the first and second water reservoirs 110 and 120 may consist of one tank or multiple separate tanks connected in series or parallel, for example, where the respective total volumes are the same.

The physical dimensions of the first and second water reservoirs 110 and 120, as well as the number of tank(s) provided for each, may vary in order to best utilize their corresponding physical or geographical locations. For example, to conserve usable space associated with a building or similar structure, the first and second water reservoirs 110 and 120 may be configured to run the height of the building, using structural corners, vertical shafts, centers of stairwells, etc. Likewise, multiple tanks connected in series or parallel may be used. The tanks of the first and second water reservoirs 110 and 120 may be lined to prevent corrosion. Applicable safety devices, such as pressure relief valves, are incorporated per applicable standards, but are not specifically shown in FIG. 1 for the sake of clarity.

Likewise, the air bank 130 is sized to provide the necessary air pressure through the entire operating period. Applicable safety devices, such as pressure relief valves, are incorporated per applicable standards, but are not specifically shown in FIG. 1 for the sake of clarity. The air pressure of the air bank 130 simulates the head pressure of a dam, for example. As discussed above with respect to the first and second water reservoirs 110 and 120, the air bank 130 may be implemented as a single tank or as multiple tanks connected in series or parallel. The tank(s) of the air bank 130 may also be lined to prevent corrosion. The air bank 130 may include valve 136, which is a maintenance drain valve.

Accordingly, before and after the operational time period (e.g., during off-peak periods), one of the first water reservoir 110 or the second water reservoir 120 is substantially full of water and the other is substantially empty. The first or second water reservoir 110 or 120 may be filled through corresponding fill valves 113 or 123 with makeup water via valve 185 and the PDP 180. The fill water and/or the make-up water may be provided from a public water supply, or from captured or filtered rain water, for example. In addition, water levels in the first and second reservoirs 110 and 120 may be further controlled, as needed, by opening and closing drain valves 115 and 125, respectively.

Generally, the air bank 130 is charged by selective operation of the air compressor 140 (e.g., during off-peak time periods) to the predetermined target air pressure. Then, during the operational time period (e.g., peak-power period plus margins), high pressure air is directed from the air bank 130 to the one of the first water reservoir 110 or the second water reservoir 120 filled with water via air pressure regulating valve 133. The high pressure air, which effectively simulates head pressure of a dam, for example, forces the water from the filled tank into the empty tank through the turbine 150, causing the water turbine 150 to spin. The spinning turbine 150, in turn, operates the generator 160, which generates electric power. After the operational time period ends, the other one of the first or second water reservoir 110 or 120 is substantially filled with water, so that during the next operational time period, the process can be reversed using the same volume of water.

In various embodiments, the controller 170 is configured to execute one or more software algorithms for controlling operations of the electric power generating system 100. The controller 170 is connected to and interfaces with various components of the electric power generating system 100 via control lines (not shown) and/or wireless communication links or network, such as a local area network (LAN). For example, the controller 170 may be connected to air valves 131-136, water valves 111-115 and 121-125, PDP valve 185, air compressor 140 and/or PDP 180 to control operations of the same. The controller 170 also may be connected to the first and second water reservoirs 110 and 120 and/or the air bank 130 to monitor respective operating conditions, such pressures and water levels, e.g., via remote sensors (not shown). The controller 170 may be a centralized controller, as shown in FIG. 1, or a distributed computer system, for example. In various alternative embodiments, operations of the electric power generating system 100 may be controlled though hardwired logic circuits, software and/or firmware provided in the controller 170 and/or distributed among one or more of the various components of the electric power generating system 100, without departing from the scope of the present teachings. Additionally, during loss of grid power, e.g., due to outages and other emergencies, the electric power generating system 100 may be operated manually, for example, by manually overriding the various valves, so long as the air bank 130 and the first and second water reservoirs 110 and 120 are ready for operation, and the air pressure regulating valve 133 is a valve that does not require control input.

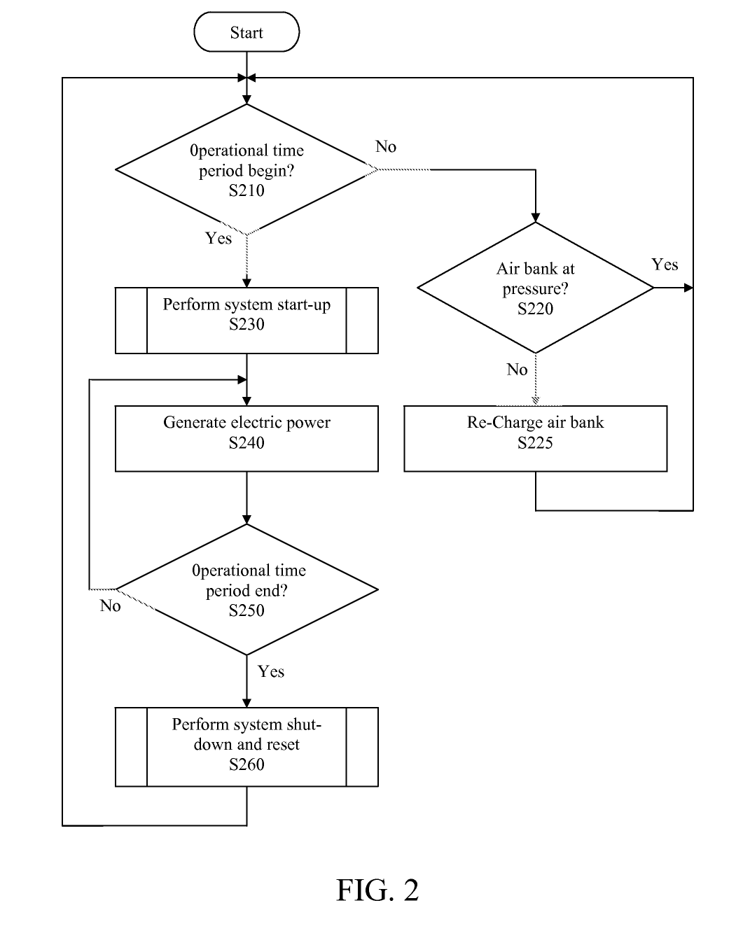

FIG. 2 is a flow diagram of a process for operating a system for generating electric power, according to a representative embodiment. In an embodiment, the process is implemented, for example, as a software algorithm executed, at least in part, by the controller 170, discussed above.

Initially, the electric power generating system 100 is in a starting condition, in which it is prepared for the next operational cycle or otherwise secured. For purposes of explaining FIG. 2, it is assumed that the first water reservoir 110 is substantially full and the second water reservoir 110 is substantially empty prior to the representative operation. As discussed above, it is assumed for purposes of explanation that the first water reservoir 110 has already been filled to required capacity, for example, through makeup water supply, prior to the initial operation. Accordingly, substantially the same volume of water passes back and forth between the first and second water reservoirs 110 and 120 through consecutive operating cycles, so that the system is reversible. However, to the extent some water is lost in the course of normal operations, make-up water may be added to the full water reservoir (the first water reservoir 110 in the present example) to assure that it is filled to the required capacity before the next operational time period begins. For example, the controller 170 may determine the water level in the first reservoir 110 and control corresponding fill valve 113, as well as the makeup water via valve 185 and the PDP 180, as needed, to top off the water level to the required capacity.

Once full, the first water reservoir 110 is isolated from the atmosphere, e.g., by closing vent valve 118. Meanwhile, the empty the second water reservoir 120 is vented to atmosphere, e.g., by opening vent valve 128, before the operational time period begins. All other valves are closed when the startup procedure begins, including air valves 131-135, water valves 111-115 and 121-125 and makeup water valve 185, and the turbine 150 and the electric generator 160 are secured. In various embodiments, the optional battery 148 is trickle charged, via the solar photo-voltaic 142, the wind generator 144, and/or the electric power grid 146 substantially continuously, e.g., regardless of whether the current time is in the operation time period.

Referring to FIGS. 1 and 2, the process begins by determining whether the current time is within an operational time period in block S210, which may be a peak-power time period plus a margin (e.g., about 15 minutes) before and after the peak-power time period to assure full functionality when needed. The peak-power time period may be determined empirically, for example, by monitoring electricity usage throughout the day. However, the operational time period may be any desired time period, peak-power or otherwise, in which need for (additional) electric power is anticipated. In various embodiments, the operational time period is a periodically occurring time period. For example, when the operation time period is a peak-power time period, the operational time period occurs daily, beginning and ending at the same time. Of course, the operational time period or peak-power time period may shift, e.g., depending on day of week and/or time of the year. Also, in various embodiments, the operational time period may not necessarily be predetermined or cyclically occurring, without departing from the scope of the present teachings. For example, the operational time period may be triggered in response to loss of power from outside power sources, such as the power grid 146, the solar photo-voltaic 142 and/or the wind generator 144.

When the current time is not in the operational time period (block S210: No), it is determined in block S220 whether the air pressure in the air bank 130 is at the predetermined target air pressure, which is the air pressure great enough to force the flow of water through the turbine 150 at a sufficient rate for the electric generator 160 to generate electricity. For example, the target air pressure may be about 5,000 psi, although other target air pressures may be implemented to provide unique benefits for any particular situation or to meet application specific design requirements of various implementations, as would be apparent to one skilled in the art.

When the air pressure is at the target air pressure (block S220: Yes), the process returns to block S210 to continue to monitor the operational time period. When the air pressure is not at the target air pressure (block S220: No), the air bank 130 is re-charged to the target air pressure in block S225. The air bank 130 is re-charged by the air compressor 140 through the dryer 141, as discussed above. More particularly, in order to re-charge the air bank 130, air valve 131 is opened, e.g., under control of the controller 170, to force compressed air into the air bank 130 from the air compressor 140. When the air pressure reaches the target air pressure, the air valve 131 is closed, and the compressor 140 and the dryer 141 are secured. The process returns to block S210 to continue to monitor the start of the operational time period.

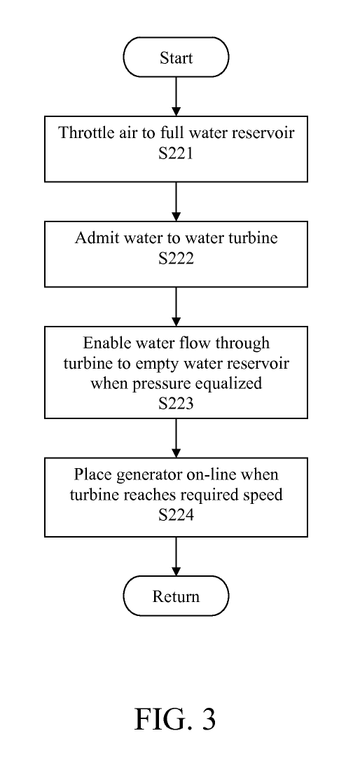

When it is determined that the current time is within the operational time period (block S210: Yes), a system start-up process is performed in block S230. FIG. 3 is a flow diagram of the system start-up process indicated by block S230 of FIG. 2, according to a representative embodiment. The process may be implemented, for example, as a software algorithm executed by the controller 170, discussed above.

Referring to FIG. 3, the system start-up process begins in block S221 with air from the air bank 130 being throttled by the air pressure regulating valve 133 to the full water reservoir, which is the first water reservoir 110 in this example. In various embodiments, the controller 170 determines which of the first or second water reservoir 110 or 120 is full and/or which is empty using sensors inside the respective water reservoirs. The air from the air bank 130 is throttled to the first water reservoir 110 by opening air valves 132, 133 and 134, e.g., under control of the controller 170.

Once the pressure in the first water reservoir 110 is raised to the required pressure, water valve 111 is opened to admit water to the turbine 150 from the first water reservoir 110 in block S222. When pressure is equalized at the turbine 150, water valve 122 throttles open in block S223, enabling water to flow from the full first water reservoir 110 to the empty second water reservoir 120 through the turbine 150, causing the turbine 150 to spin. When the turbine 150 reaches the required speed, the electric generator 160 is started electrically and placed on-line in block S224, completing start-up.

The process then returns to block S240 of FIG. 2, where the supplemental electric power generating system 100 generates electric power through continuous operation of the turbine 150 and the electric generator 160, while water continues flowing from the first water reservoir 110 to the second water reservoir 120. Meanwhile, time is monitored in block S250 to determine when the operational time period ends. When the current time indicates that the operational time period has not ended (block S250: No), the process returns to block S240 and the supplemental electric power generating system 100 continues to generate electricity. When the current time indicates that the operational time period has ended (block S250: Yes), a system shut-down and reset process is performed in block S260.

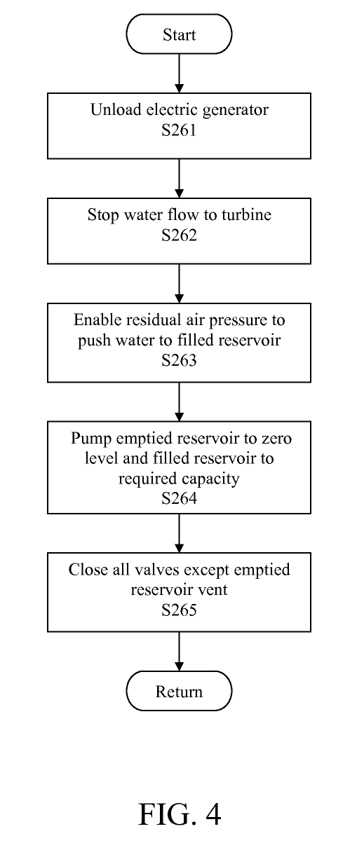

FIG. 4 is a flow diagram of the system shut-down and reset process indicated by block S260 of FIG. 2, according to a representative embodiment. The process may be implemented, for example, as a software algorithm executed by the controller 170, discussed above.

Referring to FIG. 4, the system shut-down and reset process begins by unloading the electric generator 160 in block S261. The electric generator 160 is then taken off-line and electrically secured. In block S262, the water flow through the turbine 150 is stopped, for example, by closing air valve 134 and water valve 111, and the turbine 150 coasts to a stop. The water valve 122 closes, as well. In various embodiments, the water valve 122 may close on its own when the water flow stops, or it may be controlled to close, e.g., under control of the controller 170.

At the end of the operational time period, the first water reservoir 110 is substantially empty, the second water reservoir 120 is substantially full and the air bank 130 is substantially depleted. For this to occur, the required capacity of water of the initially full first water reservoir 110 must be sufficient to enable water to flow at the rate needed to spin the turbine 150 at the required speed over the entire operational time period, with only a small amount of water left over in the fist water reservoir 110. Accordingly, very little remaining water must be pumped from the first water reservoir 110 into the second water reservoir 120 as discussed below in order to reset the supplemental electric power generating system 100 for the next operating cycle.

Any remaining water in the initially full first water reservoir 110 is transferred to the initially empty second water reservoir 120 in blocks S263 and S264. For example, in block S263, water valves 114 and 123 are opened, e.g., under control of the controller 170, to enable residual air pressure in the first water reservoir 110 to push water through the PDP 180 and water valve 123 into the second water reservoir 120. When the first water reservoir 110 reaches atmospheric pressure, vent valve 118 opens, and the PDP 180 starts in block S264 to pump down the first reservoir 110 to zero level and to fill the second reservoir 120 to the required capacity. As discussed above, make-up water may be added to the second reservoir 120 to top off the water level, as needed. Water levels in the first and second reservoirs 110 and 120 may be further controlled by opening and closing drain valves 115 and 125, respectively, if needed. In block S265, all valves are closed, except vent valve 118 of the now emptied first water reservoir 110, and the PDP 185 is secured. The process then returns to block S210 of FIG. 2, where time is again monitored to determine the beginning of the next operational time period.

As stated above, the operating cycle depicted in FIGS. 2-4 is then repeated when the next operational time period begins, e.g., about 24 hours after the previous operational time period began. The process is substantially the same, except that, in the present example, the second water reservoir 120 is initially full and the first water reservoir 110 is initially empty.

More specifically, referring again to FIG. 2, the current time is compared with the operational time period in block S210. When the current time is not in the operational time period (block S210: No), it is determined in block S220 whether the air pressure in the air bank 130, which has been substantially depleted during the previous operating cycle, is at the predetermined target air pressure. When the air pressure is not at the target air pressure (block S220: No), the air bank 130 is re-charged to the target air pressure in block S225, as discussed above.

When it is determined in block S210 that the current time is within the operational time period (block S210: Yes), the system start-up process is performed in block S230, a representative embodiment of which is depicted FIG. 3. In block 5221 of FIG. 3, the air from the air bank 130 is throttled by the air pressure regulating valve 133 to the full water reservoir, which is now the second water reservoir 120. The air from the air bank 130 is throttled to the second water reservoir 120 by opening air valves 132, 133 and 135, e.g., under control of the controller 170. Once the pressure in the second water reservoir 120 is raised to the required pressure, water valve 121 is opened to admit water to the turbine 150 from the second water reservoir 120 in block S222. When pressure is equalized at the turbine 150, water valve 112 throttles open in block S223, enabling water to flow from the full second water reservoir 120 to the empty first water reservoir 110 through the turbine 150, causing the turbine 150 to spin. When the turbine 150 reaches the required speed, the electric generator 160 is started electrically and placed on-line in block S224, completing start-up.

The process then returns to block S240 of FIG. 2, where the supplemental electric power generating system 100 generates electric power through continuous operation of the turbine 150 and the electric generator 160, while water continues flowing from the second water reservoir 120 to the first water reservoir 110. Meanwhile, time is monitored in block S250 to determine when the operational time period ends. When the current time indicates that the operational time period has not ended (block S250: No), the process returns to block S240 and the supplemental electric power generating system 100 continues to generate electricity. When the current time indicates that the operational time period has ended (block S250: Yes), a system shut-down and reset process is performed in block S260, a representative embodiment of which is depicted FIG. 4.

In block S261 of FIG. 4, the electric generator 160 is unloaded, taken off-line and electrically secured. In block S262, the water flow through the turbine 150 is stopped, for example, by closing air valve 135 and water valve 121, and the turbine 150 coasts to a stop. The water valve 112 closes, as well, as discussed above with respect to the water valve 122. Now, the second reservoir 120 is substantially empty the first water reservoir 110 is substantially full and the air bank 130 is substantially depleted. Any remaining water in the second water reservoir 120 is transferred to the first water reservoir 110 in blocks S263 and S264. For example, in block S263, water valves 124 and 113 are opened, e.g., under control of the controller 170, to enable residual air pressure in the second water reservoir 120 to push water through the PDP 180 and water valve 113 into the first water reservoir 110.

When the second water reservoir 120 reaches atmospheric pressure, vent valve 128 opens, and the PDP 180 starts in block S264 to pump down the second reservoir 120 to zero level and to fill the first reservoir 110 to the required capacity. As discussed above, make-up water may be added to the first reservoir 110 to top off the water level, as needed. In block S265, all valves are closed, except vent valve 128 of the now emptied second water reservoir 120, and the PDP 180 is secured. The process then returns to block S210 of FIG. 2, where time is again monitored to determine the beginning of the next operational time period, as discussed above.

The sizes and/or capacities of the various components of electric power generating system 100 discussed above may vary to provide unique benefits for any particular situation or to meet application specific design requirements of various implementations, as would be apparent to one skilled in the art. For example, the first and second water reservoirs 110 and 120 may each have a volume of about 600,000 gallons in order to support an operational time period of about 5 hours of peak-power, plus about 15 minutes of excess capacity as a margin. The normal operating pressure of the full one of the first or second water reservoir 110 or 120 may be about 40 psi, for example, which simulates about 100 feet of head. To produce this pressure, the air bank 130 may be configured to hold about 4,800 ft³ of air pressurized to about 5,000 psi. As stated above, each of the first and second water reservoirs 110 and 120 and/or the air bank 130 may consist of a single tank or multiple tanks connected in series.

In this representative configuration, the air compressor 140 may be a four-stage, reciprocating compressor, having a maximum working pressure of about 5,000 psi and an application working pressure of about 2,500 psi, for example. Accordingly, the air compressor 140 would be able to fill the air bank 130 with air pressurized to about 5,000 psi during the off-peak utility rate hours. As stated above, the air compressor 140 would be operated only during times outside the operational time period. An example of an air compressor 140 is a Model IVE150-15 E3 compressor, available from Bauer Compressors, Inc., although other sizes, types and models of air compressors may be incorporated without departing from the scope of the present teachings.

Also, the PDP 180 may be an electric pump capable of pumping about 10,000 gallons of residual water from one of the first or second water reservoirs 110 or 120 to the other one of the first or second water reservoirs 110 or 120 after the operational time period has ended, as discussed above with respect to block S264 of FIG. 4. Assuming that the residual water is to be pumped over in about 5 hours, the PDP 180 would require a pump rate of about 35 gpm. Like operation of the air compressor 140, operation of the PDP 180 would occur only during times other than the operational time period (e.g., during off-peak times). Of course, other sizes and types of pumps may be incorporated without departing from the scope of the present teachings. For example, the PDP 180 may be implemented alternatively as an air powered pump, e.g., optionally powered by the air compressor 140.

The turbine 150 is sized to provide the required energy to operate the generator 160 at peak-power, and the generator 160 is sized to provide the required KVA/KW load to be produced, e.g., in order to meet the desired power shedding. For example, the turbine 150 may be a Byron Jackson axial flow vertical shaft turbine (e.g., Model 10H TKW 1200) and the generator 160 may be a 200 KW General Electric induction generator, although other sizes, types and models of turbines and generators may be incorporated without departing from the scope of the present teachings.

Notably, the air valves 131-136, the water valves 111-115 and 121-125, and the PDP valve 185 are depicted as shut-off valves, for convenience of explanation. However, it is understood that various other types of valves may be implemented, as dictated by required flow rates, pressures, codes etc., as would be apparent to one of ordinary skill in the art, without departing from the scope of the present teachings. All or a portion of the air valves 131-136, the water valves 111-115 and 121-125, and the PDP valve 185, may be configured to be controlled remotely, e.g., by the controller 170, as discussed below. In various embodiments, devices such as a mechanical air reducing valve, may be used in place of the air pressure regulating valve 133, instead of a computer controlled device. Additionally, manual, electrical, pneumatic and/or hydraulic positioned valves may be incorporated, without departing from the scope of the present teachings.

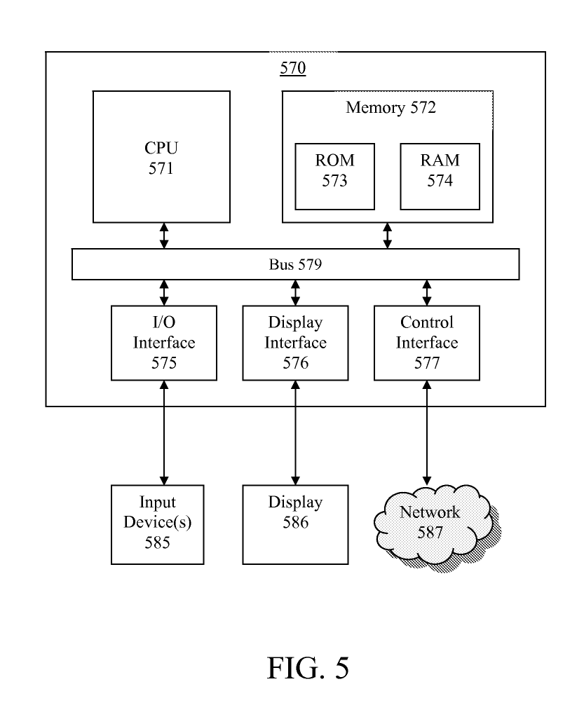

As stated above, the controller 170 may be any type of computer system or processor capable of executing an algorithm for controlling the electric power generating system 100, in accordance with various embodiments. As stated above, the controller 170 may communicate with the air valves 131-136, the water valves 111-115 and 121-125 and the PDP valve 185 to open and close the same, and with the air compressor 140 and the PDP 180 to start and stop the same, in accordance with operations of the electric power generating system 100. The controller 170 may also receive and monitor feedback from sensors (not shown) distributed throughout various components of the electric power generating system 100. For example, air pressure sensors in the air bank 130 provide information that the controller 170 may use to determine when to start the air compressor 140 and to open the air valve 131 to re-charge the air bank 130. Also, water level sensors in the first and second water reservoirs 110 and 120 provide information that the controller 170 may use to determine which of the water reservoirs is full or empty, whether residual water remains in the otherwise empty water reservoir (requiring operation of the PDP 180), whether make-up water is needed in the otherwise full water reservoir, etc. The controller 170 may communicate with the various components via control lines and/or wirelessly. An illustrative embodiment of the controller 170 is discussed below with reference to FIG. 5.

FIG. 5 is a functional block diagram illustrating a computer system 570, for executing an algorithm to control operations of the electric power generating system 100, according to a representative embodiment. The computer system 570 may be any type of computer processing device, such as a PC, capable of executing the various steps of the programming language translation process.

In the depicted representative embodiment, the computer system 570 includes central processing unit (CPU) 571, memory 572, bus 579 and interfaces 575-577. Memory 572 includes at least nonvolatile read only memory (ROM) 573 and volatile random access memory (RAM) 574, although it is understood that memory 572 may be implemented as any number, type and combination of ROM and RAM and of internal and external memory. Memory 572 may provide look-up tables and/or other relational functionality. In various embodiments, the memory 572 may include any number, type and combination of tangible computer readable storage media, such as a disk drive, compact disc (e.g., CD-R/CD/RW), electrically programmable read-only memory (EPROM), electrically erasable and programmable read only memory (EEPROM), DVD, universal serial bus (USB) drive, diskette, floppy disk, and the like. Further, the memory 572 may store program instructions and results of calculations performed by CPU 571.

The CPU 571 is configured to execute one or more software algorithms, including control of the electric power generating system 100 according to various embodiments described herein, e.g., in conjunction with memory 572. The CPU 571 may include its own memory (e.g., nonvolatile memory) for storing executable software code that allows it to perform the various functions. Alternatively, the executable code may be stored in designated memory locations within memory 572. The CPU 571 may execute an operating system, such as Windows® operating systems available from Microsoft Corporation or Unix operating systems (e.g., Solaris™ available from Sun Microsystems, Inc.), and the like.

In an embodiment, a user and/or other computers may interact with the computer system 570 using input device(s) 585 through I/O interface 575. The input device(s) 575 may include any type of input device, for example, a keyboard, a track ball, a mouse, a touch pad or touch-sensitive display, and the like. Also, information may be displayed by the computer system 570 on display 586 through display interface 576, which may include any type of graphical user interface (GUI), for example.

The computer system 570 may also include a control interface 577 for communicating with various components of the electric power generating system 100. Various types of interfaces may be selected to work with the other chosen equipment, as would be apparent to one of ordinary skill in the art. For example, in various embodiments, the computer system 570 is able to communicate with the air valves 131-136, the water valves 111-115 and 121-125, the PDP valve 185, the PDP 180, the air compressor 140 and/or the first and second water reservoirs 110 and 120, as discussed above, via a wired or wireless LAN, indicated by network 587. The control interface 577 may include, for example, a transceiver (not shown), including a receiver and a transmitter, that communicates wirelessly over a data network through an antenna system (not shown), according to appropriate standard protocols. However, it is understood that the control interface 577 may include any type of interface (wired or wireless), without departing from the scope of the present teachings.

The various “parts” shown in the computer system 570 may be physically implemented using a software-controlled microprocessor, hard-wired logic circuits, or a combination thereof. Also, while the parts are functionally segregated in the computer system 570 for explanation purposes, they may be combined variously in any physical implementation.

The various components, materials, structures and parameters are included by way of illustration and example only and not in any limiting sense. In view of this disclosure, those skilled in the art can implement the present teachings in determining their own applications and needed components, materials, structures and equipment to implement these applications, while remaining within the scope of the appended claims.

1. A reversible system for selectively generating electric power, the system comprising:
a first reservoir initially containing a predetermined volume of water;
a second reservoir initially being substantially empty of water;
a turbine selectively connectable to the first reservoir and the second reservoir through a plurality of valves;
a generator connected to the turbine and configured to generate the electric power in response to spinning of the turbine;
an air bank configured to contain compressed air at a predetermined target pressure, the air bank selectively providing pressurized air to the first reservoir during an initial operational time period to increase an internal pressure of the first reservoir; and
an air compressor configured to operate only at times other than the initial operational time period to charge the air bank to the predetermined pressure,
wherein at least a first valve of the plurality valves is opened during the initial operational time period to enable the predetermined volume of water to flow from the first reservoir through the turbine to the second reservoir, in response to the increased internal pressure of the first reservoir, causing the turbine to spin and the generator to generate electric power.

2. The system of claim 1, wherein the second reservoir substantially contains the predetermined volume of water and the first reservoir is substantially empty of water following the initial operational time period.

3. The system of claim 2, wherein the air bank selectively provides pressurized air to the second reservoir during a subsequent operational time period to increase an internal pressure of the second reservoir.

4. The system of claim 3, wherein the air compressor recharges the air bank to the predetermined pressure between the initial operational time period and the subsequent operational time period.

5. The system of claim 3, wherein at least a second valve of the plurality valves is opened during the subsequent operational time period to enable the predetermined volume of water to flow from the second reservoir through the turbine to the first reservoir, in response to the increased internal pressure of the second reservoir, causing the turbine to spin and the generator to generate electric power.

6. The system of claim 1, wherein the increased internal pressure of the first reservoir simulates a head pressure of a dam.

7. The system of claim 1, wherein the initial operational time period is one of a plurality of periodically occurring operational time periods corresponding to daily peak-power periods.

8. The system of claim 7, wherein the air compressor is configured to operate only during off-peak times.

9. The system of claim 8, further comprising:
a battery connected to the air compressor to provide power for the operation of the air compressor; and
a renewable energy source configured to charge the battery.

10. The system of claim 9, wherein the renewable energy source comprises at least one of a solar photo-voltaic and a wind turbine.

11. The system of claim 1, wherein at least one of the first reservoir and the second reservoir comprises a single water tank.

12. The system of claim 1, wherein at least one of the first reservoir and the second reservoir comprises a plurality of water tanks connected in series.

13. The system of claim 5, further comprising:
a pump down pump (PDP) configured to pump residual water from the first reservoir into the second reservoir following the initial operational period, and to pump residual water from the second reservoir into the first reservoir following the subsequent operational period.

14. The system of claim 5, further comprising:
a controller configured to execute a software algorithm for controlling operations of the plurality of valves to enable the predetermined volume of water to flow from the first reservoir through the turbine to the second reservoir during the initial operational time period, and to enable the predetermined volume of water to flow from the second reservoir through the turbine to the first reservoir during the subsequent operational time period.

15. The system of claim 14, wherein the controller further executes a software algorithm for controlling operations of the air bank to selectively provide pressurized air to the first and second reservoirs during the initial and subsequent operational time periods, respectively, and for controlling the air compressor to operate only at times other than the initial and subsequent operational time periods.

16. The system of claim 1, wherein at least one of the first reservoir and the second reservoir has a substantially vertical orientation for placement within a vertical shaft or a center portion of a stairwell in a building.

17. A method for generating electric power only during periodically occurring operational time periods, the method comprising:
charging air in an air bank to a target pressure prior to an initial operational time period;
throttling the pressurized air from the air bank to a first reservoir during the initial operational time period to increase an internal pressure of the first reservoir, the first reservoir containing a predetermined volume of water;
opening a first plurality of valves to enable at least a portion of the predetermined volume of water to flow in response to the increased internal pressure from the first reservoir through a turbine into a second reservoir, causing the turbine to operate a generator connected to the turbine for generating electric power;
closing the first plurality of valves when the initial operational time period ends;
charging air in the air bank to the target pressure after the initial operation time period and prior to a subsequent operational time period;
throttling the pressurized air from the air bank to the second reservoir during the subsequent operational time period to increase an internal pressure of the second reservoir, the second reservoir containing the portion of the predetermined volume of water received from the first reservoir;
opening a second plurality of valves to enable the portion of the predetermined volume of water to flow in response to the increased internal pressure from the second reservoir through the turbine into the first reservoir, causing the turbine to operate the generator connected to the turbine for generating electric power; and
closing the second plurality of valves when the subsequent operational time period ends.

18. The method of claim 17, further comprising:
pumping residual water from the first reservoir into the second reservoir following the initial operational period; and
pumping residual water from the second reservoir into the first reservoir following the subsequent operational period.

19. The method of claim 18, the initial operational time period and the subsequent operational time period are consecutive peak-power periods.

20. A system for generating electric power only during a first time period, the system comprising:
an air bank configured to contain compressed air at a predetermined pressure;
an air compressor configured to charge the air bank to the predetermined pressure only during a second time period different from the first time period;
a first tank configured to contain a predetermined volume of water;
a second tank configured to contain the predetermined volume of water, the second tank being connected to the first tank through at least one valve operable to enable the predetermined volume of water to be transferred between the first and second tanks;
a turbine configured to receive through the at least one valve the predetermined volume of water being transferred between the first and second tanks; and
a generator configured to generate the electric power by operation of the turbine,
wherein the portion of the predetermined volume of water is transferred from one of the first tank or the second tank to the other one of the first tank or the second tank during the first time period in response to pressure from the compressed air provided by the air bank.
